(19) United States
(12) Patent Application Publication
(10) Pub. No.: US 2010/0312607 A1
(43) Pub. Date: Dec. 9, 2010

(54) ADVERTISEMENT DELIVERY METHOD

(76) Inventor: Thomas Grant Kidd, Dundee (GB)

Correspondence Address: PAUL W. MARTIN, NCR CORPORATION, LAW DEPT., 3097 SATELLITE BLVD., 2nd FLOOR, DULUTH, GA, 30096, US

(21) Appl. No.: 12/477,639

(22) Filed: Jun. 3, 2009

(51) Int. Cl. G06Q 30/00; G01C 21/00; G06Q 99/00

(52) U.S. Cl. 705/10; 701/300; 705/27; 705/14.62; 705/14.63

(57) ABSTRACT

An advertisement delivery method for occupants of vehicles. The advertisement delivery method includes determining an advertisement by a host computer system, and sending the advertisement to a computer system in a vehicle by the host computer system.

### BACKGROUND

Advertisers may deliver targeted promotions based upon a variety of criteria, including where people live. However, these methods are ineffective when applied to people who travel.

For example, people traveling in automobiles are unable to receive targeted advertisements through computers.

Therefore, it would be desirable to provide an advertisement delivery method that would allow travelers, such as people in automobiles, to receive targeted advertisements.

### SUMMARY

An advertisement delivery method is provided.

The advertisement delivery method includes determining an advertisement by a host computer system, and sending the advertisement to a computer system in a vehicle by the host computer system.

### BRIEF DESCRIPTION OF THE DRAWINGS

FIG. 1 is a block diagram of a network of computers.

FIG. 2 is a flow diagram illustrating an example advertisement delivery method.

### DETAILED DESCRIPTION

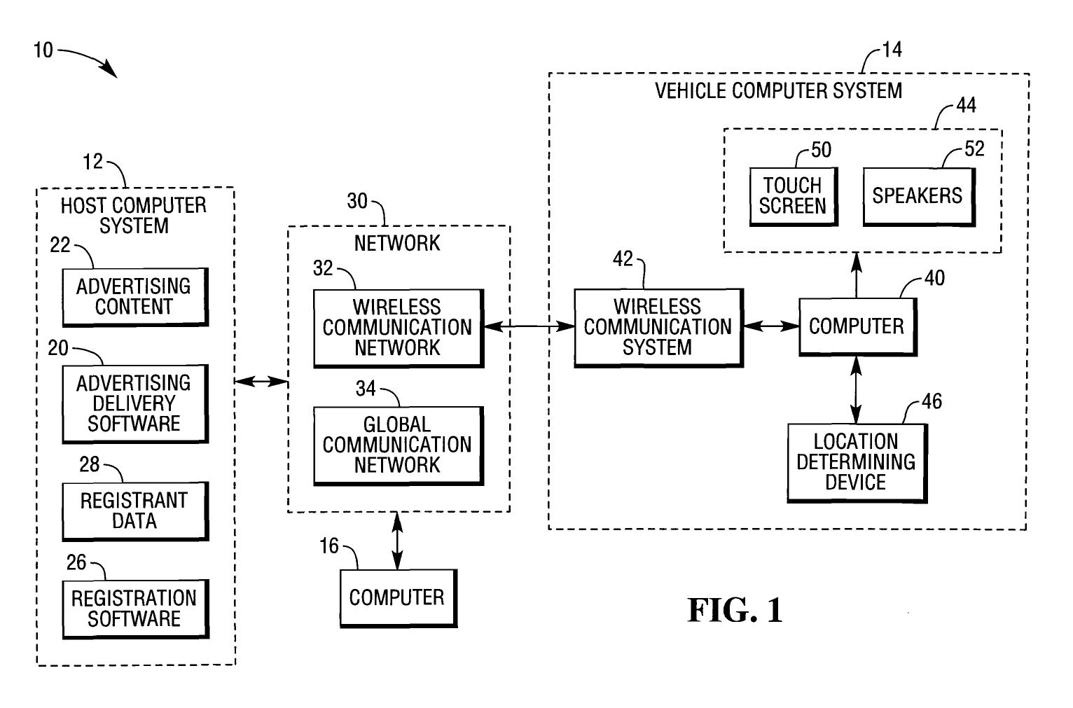

With reference to FIG. 1, example system 10 primarily includes host computer system 12 and vehicle computer system 14.

Host computer system 12 may include one or more computers for the purpose of managing delivery of advertisements. Host computer system 12 is equipped to deliver advertisements to travelers in vehicles equipped with vehicle computer system 14, such as travelers in automobiles.

Advertisers provide advertisements which are stored as advertisement content 22 by host computer system 12. Host computer system 12 may obtain advertisements from advertiser host computer systems.

Host computer system 12 executes advertisement delivery software 20, which determines advertisements to broadcast to vehicle computer system 14 from advertisement content 22.

An operator of host computer system 12 may receive a subsidy from advertisers in return for delivering advertisements. Advertisement delivery software 20 may broadcast advertisements according to a schedule established with sponsors. Host computer system 12 is equipped with a built-in clock which is synchronized with a current time and date.

Advertisement delivery software 20 may broadcast all advertisements and let vehicle occupants decide which advertisements are of interest based upon their location. For example, advertisement delivery software 20 may broadcast advertisements according to a schedule.

Advertisement delivery software 20 may alternatively broadcast the advertisements based upon locations of sponsors. Different locations may receive different broadcasts.

For example, advertisement delivery software 20 may broadcast a promotion for a particular restaurant within a predetermined number of miles of the restaurant. Vehicles within communication range of the broadcasts receive the advertisements.

Advertisement delivery software 20 may also broadcast advertisements directed to specific vehicles whose occupants have pre-registered to receive advertisements. Vehicle computer system 14 is tuned to receive the broadcasts. For this purpose, host computer system 12 may also execute registration software 26, which facilitates registration of people who, in return for supplying personal preferences, vehicle computer system information and/or vehicle identification information, receive advertisements that are more effective and appropriate based upon their personal preferences. Host computer system 12 maintains the personal preferences and vehicle computer system information in registrant data 28.

A person may connect to host computer system 12 for the purpose of entering personal preferences from vehicle computer system 14. Network communication between vehicle computer system 14 and host computer system 12 may be wireless through wireless communication network 32, or a combination of wireless and wire based communication involving global communications network 34, which may include the Internet.

As another example, a person may connect to host computer system 12 from computer 16, which may include a personal computer or portable computing device, such as a cellular telephone or other wireless handheld device. Customer computer 16 includes a processor, memory, program and data storage, a display, and one or more user input devices. Network communication between computer 16 and host computer system 12 may be wireless through wireless communication network 32, or a combination of wireless and wire based communication involving global communications network 34.

For example, advertisement delivery software 20 may determine that a registered vehicle is within a predetermined number of miles of a particular hotel and broadcast a promotion for the hotel to vehicle computer system 14.

Advertisement delivery software 20 may receive vehicle location information from any of a variety of sources. For example, advertisement delivery software 20 may receive vehicle location information from vehicle computer system 14. Vehicle computer system 14 may receive vehicle location information from location determining device 46, which may include a global positioning system (GPS) receiver.

As another example, advertisement delivery software 20 may receive vehicle location information from wireless communication network 32, which identifies one or more communication stations through which vehicle computer system 14 is currently communicating and sends the station locations to advertisement delivery software 20.

As yet another example, the vehicle may be equipped with a vehicle identification device, such as a radio frequency identification (RFID) tag. Host computer system 12 may receive vehicle identification and location information from monitoring check points as the vehicle passes by.

Vehicle computer system 14 includes computer 40, wireless communication system 42, and user interface 44. Computer 40 includes a processor, memory, and program and data storage. Computer 40 connects to host computer system 12, but may have one or more additional purposes besides receiving and presenting advertisements.

Vehicle computer system 14 may be integrated into a vehicle or be carried within the vehicle by an occupant. The vehicle may be in motion or still, for example, parked. If still, the vehicle may be in a state in which the vehicle's engine is turned on or off.

Wireless communication system 42 wirelessly communicates with wireless communications network 32. Wireless communication system 42 receives advertisements from host computer system 12. Wireless communication system 42 may also convey vehicle location information to host computer system 12.

User interface 44 may include a touch screen 50 and speakers 52. Touch screen 50 displays video advertisements and facilitates user inputs and selections. Speakers 52 play audio advertisements and audio that accompanies video advertisements. If vehicle computer system 14 is in an automobile, computer 40 may disable video display if only a driver is present and the automobile is in motion.

Vehicle computer system 14 may also include location determining device 46 if the vehicle is pre-registered with host computer system 12. Location determining device 46 may include a GPS receiver.

In an example embodiment, host computer system 12 may include a primary web site, such as a home page, with a uniform resource locator (URL) or web address. Vehicle computer system 14 may execute browser software for connecting to this web site and receiving advertisements. Host computer system 12 and vehicle computer system 14 may be configured with a network protocol, such as the transmission control protocol/internet protocol (TCP/IP). Pre-registered vehicles may automatically connect to this web site. A person may connect to a registration web page of host computer system 12 for the purpose of entering personal preferences and registering a vehicle.

Advertising delivery software 20 may deliver advertisements in any format, such as Adobe Flash files. Advertising delivery software 20 may deliver the advertisements in any method, such as via conventional download or via streaming.

To deliver advertisements based upon location, host computer system 12 may include a plurality of different secondary web sites for delivering advertisements to specific areas. A vehicle passing into one of the areas may connect to a corresponding web site, either automatically in the case of pre-registered vehicles, or upon occupant selection.

A combination of the two methods is also envisioned. Vehicle computer system 14 may connect by default to the primary web site initially, then to secondary web sites, either automatically or upon occupant selection, based upon current location.

The advertising process may be interactive. Vehicle occupants may send requests for additional information, download e-coupons, and perform other tasks related to the advertisements they receive.

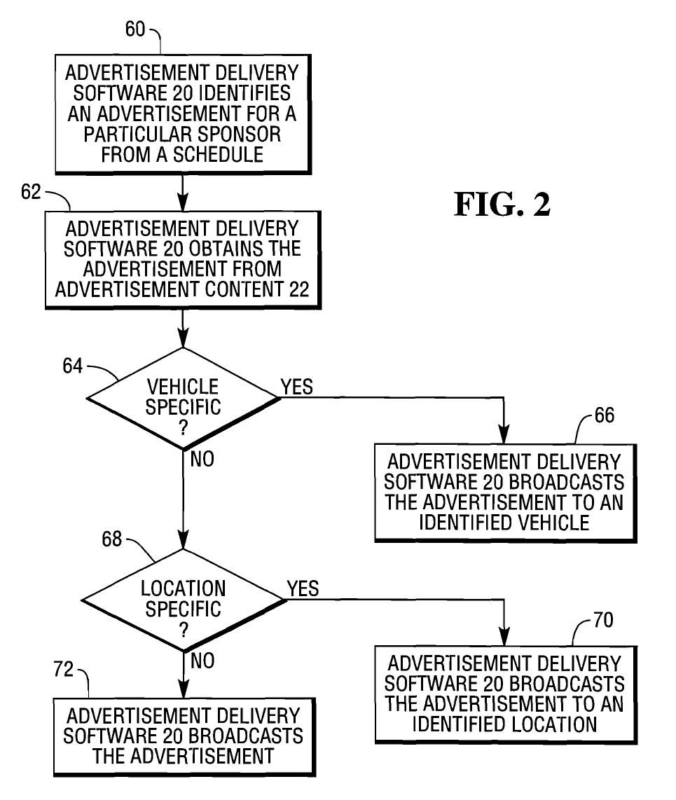

With reference to FIG. 2, an example method of operation is illustrated.

In step 60, advertisement delivery software 20 identifies an advertisement for a particular sponsor from a schedule.

In step 62, advertisement delivery software 20 obtains the advertisement from advertisement content 22.

In step 64, advertisement delivery software 20 determines whether the advertisement is directed to a particular vehicle. If so, operation proceeds to step 66. Otherwise, operation continues to step 68.

In step 66, advertisement delivery software 20 broadcasts the advertisement to an identified vehicle.

In step 68, advertisement delivery software 20 determines whether the advertisement is directed to a particular area. If so, operation proceeds to step 70. Otherwise, operation continues to step 72.

In step 70, advertisement delivery software 20 broadcasts the advertisement to an identified area.

In step 72, advertisement delivery software 20 broadcasts the advertisement.

Vehicle computer system 14 receives the broadcast and provides audio or both audio and video to vehicle occupants.

As in the one example embodiment, advertisement delivery software 20 may provide the advertisement through a web page. Vehicle computer system 14 connects to the web page and receives the advertisement.

The above steps may be rearranged based upon vehicle detection. For example, if advertisement delivery software 20 determines that a pre-registered vehicle has been identified, advertisement delivery software 20 may follow vehicle identification with advertisement determination and delivery.

Although particular reference has been made to certain embodiments, variations and modifications are also envisioned within the spirit and scope of the following claims.

What is claimed is:

1. An advertisement delivery method comprising:
determining an advertisement by a host computer system; and
sending the advertisement to a computer system in a vehicle by the host computer system.

2. The method of claim 1, wherein the determining step comprises:
determining the advertisement from a schedule by the host computer system.

3. The method of claim 1, wherein the determining step comprises:
obtaining a current location of the vehicle by the host computer system; and
determining the advertisement based upon the current location by the host computer system.

4. The method of claim 3, wherein the obtaining step comprises:
obtaining the current location from the computer system in the vehicle based upon global positioning system information in the vehicle.

5. The method of claim 3, wherein the obtaining step comprises:
obtaining the current location from wireless network stations through which the computer system in the vehicle is currently communicating by the host computer system.

6. The method of claim 3, wherein the obtaining step comprises:
obtaining the current location from checkpoints that detect a radio frequency identification tag in the vehicle by the host computer system.

7. The method of claim 1, wherein the determining step comprises:
recording preferences of an occupant of the vehicle by the host computer system; and
determining the advertisement based upon the preferences by the host computer system.

8. The method of claim 1, wherein the sending step comprises:
sending the advertisement in audio format.

9. The method of claim 1, wherein the sending step comprises:
sending the advertisement in video format.

10. The method of claim 1, further comprising:
receiving selections made by an occupant of the vehicle from the computer system of the vehicle by the host computer system.

11. An advertisement delivery method comprising:
establishing an Internet connection with a computer system of a vehicle by a host computer system;
determining a web advertisement capable of being presented by web browser software executed by the computer system of the vehicle by the host computer system; and
sending the advertisement to the computer system of the vehicle by the host computer system.

12. The method of claim 11, wherein the determining step comprises:
obtaining a current location of the vehicle by the host computer system; and
determining the advertisement based upon the current location by the host computer system.

13. The method of claim 11, wherein the determining step comprises:
recording preferences of an occupant of the vehicle by the host computer system; and
determining the advertisement based upon the preferences by the host computer system.

14. The method of claim 11, further comprising:
receiving selections related to the web advertisement made by an occupant of the vehicle from the computer system of the vehicle by the host computer system.

15. An advertisement delivery method comprising:
recording preferences of an occupant of a vehicle by a host computer system;
obtaining a current location of the vehicle by the host computer system;
determining an advertisement based upon at least one of the preferences, the current location, and a schedule by the host computer system; and
sending the advertisement to a computer system in the vehicle by the host computer system;
